(19) United States
(12) Patent Application Publication
(10) Pub. No.: US 2010/0268602 A1
(43) Pub. Date: Oct. 21, 2010

(54) System and method for direct marketing using electronic messaging to individuals within an interrogation zone

(76) Inventors: Lorena Virginia Rodriguez, Key Biscayne, FL (US); Martin Carlos Larretape, Key Biscayne, FL (US)

Correspondence Address: MALLOY & MALLOY, P.A., 2800 S.W. Third Avenue, Historic Coral Way, Miami, FL, 33129, US

(21) Appl. No.: 12/456,893

(22) Filed: Jun. 24, 2009

Related U.S. Application Data
(63) Continuation-in-part of application No. 12/386,589, filed on Apr. 21, 2009.

(51) Int. Cl. G06Q 30/00

(52) U.S. Cl. 705/14.53; 705/14.58

(57) ABSTRACT

A system and method of direct marketing to individual(s) within an interrogation zone by the presentation of customize or personalize messages to the individual selected. A plurality of tags each associated with at least one individual include response capabilities which are monitored by a reader and/or associated processor facility capable of generating interrogation signaling into the interrogation zone for purposes of activating any of the plurality of tags present therein. Upon activation, each of the plurality of tags generates and transmits identification data back to the reader or processor facility, which includes an individual identifier corresponding to the individual associated with the tag. The individual identifier facilitates access to classification data of a corresponding individual, collectively stored on the processor facility or individually stored on each of the tags, wherein the classification data enables the processor facility to determine a hierarchy or selection order of the monitored individuals present within the interrogation zone and as a result the individual to which the marketing message will be directed.

### CLAIM OF PRIORITY

The present application is a continuation-in-part application of previously filed, now pending application having Ser. No. 12/386,589, filed on Apr. 21, 2009 incorporated herein by reference in its entirety.

### BACKGROUND OF THE INVENTION

1. Field of the Invention

This invention relates to a system and method of marketing by directing customized and/or personalized electronic or other appropriate presentations, containing customer and/or purchasing advantages, to at least one of a plurality of individuals located within a predetermined interrogation zone and being in the possession of an RFID tag. The tags are activated causing the transmission of identification data, identifying the individuals in possession of the tags, to a tag reader and/or processor facility. The selection of individual(s) to which the marketing presentation is made may be based on purchasing history and other factors included within a customer/individual's profile, which are determinative of a selection order of the plurality of individuals being monitored.

2. Description of the Related Art

Advertising and marketing is conducted on a substantially continuous basis in all industrialized countries throughout the world. As such, attempts are made to render an advertising or marketing message more efficient, by directing an advertising campaign to a group of customers, which would be most interested in a particular product or service.

While most advertising is done on a widely exposed media basis, attempts have been made to more efficiently determine smaller groupings of potential customers which may be more receptive to specific marketing messages. Frequently, the segregation of the market, in terms of customers' interest, is often based on a customer's history which in turn may be indicative of goods or services a customer or group of customers may be most interested. Of course, a customer's history may include other factors including purchasing history as well as demographics including age, gender, economic level, geographical location etc.

Known or conventional attempts to define smaller segments or groupings of potential customers recognize the advantages, in terms of efficiency in utilizing and planning an advertising budget. As a result, it is understood that the cost of advertising would be reduced or at least more efficiently utilized, based on the ability to structure or design the content of the presented advertising to accommodate a specific segment of society which is more interested in the product or service being advertised.

Some of the conventional or known systems and methods of identifying specific groupings of individuals, for a variety of purposes, involve the use of wireless communication conducted between a control or operating entity and a plurality of individuals by utilizing radio frequency identification (RFID) tags. The broad concept of establishing bi-directional communication, of the type generally set forth above, has been utilized with at least minimal success in many areas of commerce. Depending on the field of use, disadvantages and problems in systems and methods of this type have been recognized which frequently render them insufficiently effective to justify cost of operation, set up, etc.

Therefore, there is a specific need in the advertising and marketing industry for a system and attendant method of providing direct marketing messages, which may be customized or personalized to a specific individual. In order to increase the desirability of having the direct marketing message presented to a specific individual it may contain various sale offers, reduced pricing, or other benefits which would not be immediately available to other individuals or customers viewing the direct marketing presentation. Therefore, an improved and proposed system and method for providing direct marketing messages to selected individuals, giving such selected individuals a “customer advantage”, would overcome many of the disadvantages and problems associated with known or conventional marketing techniques of the type generally set forth above.

Further, such a proposed system and method would have the ability to provide a selection order or hierarchy among the individuals being monitored throughout a predetermined interrogation zone. Such a selection order would be at least partially based on an individual's history and may involve an individual's purchasing history or pattern, frequency of visiting a given outlet, gender, economic level, etc. Further, such a proposed system would be capable of implementing the aforementioned selection order or hierarchy based on the most current and therefore relevant customer history by allowing such information to be continuously or periodically modified or “updated”. Further, the specificity of such updated information could include the most recent customer activity with regard to a specific outlet sponsoring or operating the direct marketing messaging.

### SUMMARY OF THE INVENTION

The present invention comprises a system and method for directing advertising or marketing to individuals within a predetermined interrogation zone, at least partially through the presentation of customized or personalized messages, which are preferably electronically displayed and observable by substantially all of a larger number of individuals within the interrogation zone. In addition, at least one preferred embodiment of the present invention comprises a tracking assembly disposed and structured to facilitate real time, “customer tracking” and/or “customer visibility” in terms of allowing a participating store or outlet operator to be aware of “customer or individual activity” in appropriate detail. As set forth hereinafter, such customer activity may include the habits of the customer relating to shopping, purchasing, browsing, etc. of at least one but more practically a plurality of the tagged customers/individuals. In more common terms, the store or outlet operators are allowed to track and/or monitor what the tagged customers or individuals do, where they go and observe their preferences while shopping. For purposes of clarity the terms “customer” and “individual” are used interchangeably when described as participants in the various preferred embodiments of the system and method of the present invention.

At least one embodiment of the present invention utilizes a wireless communication technique incorporating a plurality of tags, preferably radio frequency identification (RFID) tags, having bi-directional communication capabilities. In addition, at least one preferred embodiment of the system and method of the present invention includes the RFID tags, which would be in the possession of potential customers, and a centrally located reader or processor facility structured to communicate with the tags, wherein the tags and reader, etc. are operative within an ultra high frequency (UHF) range. As a result, the interrogation zone in which a plurality of individuals or customers in possession of the tags may be disposed may be significantly enlarged. The interrogation zone may include large areas within a mall or other retail, wholesale or distribution environment and may be associated with one or more kiosks or other facilities for containment of the reader(s), monitors and/or display facilities, for presenting the marketing messages as well as at least one customer interface.

However, as indicated hereinafter, at least one preferred embodiment of the present invention includes a tracking system comprising one or more monitors, readers, transceivers and/or other appropriate tracking facilities located thorough out or at predetermined locations associated with a given outlet. Therefore, the system and method of the present invention facilitates “customer tracking” and/or “customer visibility” in terms of allowing a participating store or outlet operator to be aware of shopping, purchasing, browsing habits, etc. of a tagged customer/individual. In more common terms, the store or outlet operators are allowed to “see” what the customers do, where they go while shopping, how long they occupy each area or department of an outlet, what merchandise they purchase or consider purchasing, what sales personnel they interact with and other factors that may enhance the customer's shopping experience and/or the sales of the outlet, merchant, etc.

The efficient operation of the various embodiments of the present invention includes the plurality of tags associated preferably being incorporated in some type of card or other appropriate device easily and typically carried on the person of the individuals. Such cards may include credit cards, reward cards or a variety of other types of devices of sufficient dimension and structure to be easily carried and accessed. However, other devices or techniques may be used to facilitate possession of the tags by the individuals or customers, which assures there presence and detection when in the interrogation zone.

The aforementioned tag reader(s) and/or processor facilities include an RF transmitter(s) having bi-directional communication capabilities so as to freely and wirelessly communicate with the RFID tags incorporated within the cards or other devices within the possession of the individual. Further, the reader, which may be directly associated with the processor facility, includes monitoring capabilities which may be more specifically defined as the ability to generate interrogation signals at least throughout the interrogation zone. Such interrogation signaling may be done on a continuously streaming basis or periodically for purposes of determining the existence of any associated RFID tags present within the interrogation zone. The interrogation signals are more specifically structured to activate the RFID tags, which in turn results in the transmission or generation from the tags to the reader/processor facilities of identification data. The identification data is generated in response to being activated by the interrogation signals and more specifically includes sufficiently adequate data to recognize or identify the individual(s) possessing the tag, at least to the extent of facilitating the classification or ranking the individual into a selection order or hierarchy of individuals also present within the interrogation zone.

More specifically, the identification data embedded within the response signal generated by the monitored tag(s) include an individual identifier and/or sufficient classification data to provide the reader or processor facility with sufficient information to identify the individual in terms of personal identification as well as individual history in terms of customer activity. Accordingly, as used herein the term “classification data” may in at least some of the preferred embodiments of the present invention be considered substantially the equivalent of a customer's profile or profile data. Based on individual's history or profile data, which may include the aforementioned “customer activity”, a hierarchy of the monitored individuals carrying the RFID tags is established and a selection is made of the highest ranking individual.

Thereafter a direct marketing presentation or marketing message may be displayed on an appropriate display assembly observable throughout at least a portion or substantially the entirety of the interrogation zone. Such a direct marketing presentation may be customized or personalized to the extent that the selected, highest ranked, individual clearly understands that the direct marketing presentation or message is directed to him or her. Accordingly, the personalized message may include an individual's name or other clearly recognizable content that informs the selected individual that the message is directed to him/her.

Further, the content of the direct marketing message will provide the selected, “highest ranking” individual with a customer advantage in terms of lower sales price, availability of new products or services or other “bargains” which may not be currently available to other individuals or customers even though they may be located in the interrogation zone and be in the possession of the associated RFID tags. Therefore it should be apparent that a “spirit of competition” may soon develop by tagged individuals that frequent the interrogation zone. More specifically, upon recognition by non-selected individuals, that the selected individual receives significant benefits in terms of purchasing advantages of various products or services, the non-selected individuals may take specific steps to increase their chances of being selected.

By way of example, individuals may visit and/or make purchases from an outlet on a more frequent basis. Alternatively and or in addition, individuals may frequent an outlet associated with the interrogation zone during “off-hours” when there is normally fewer customers present. All of these activities may “improve” an individual's history thereby raising their hierarchy and selection order and result in a better chance of being selected. It should be equally apparent that an increase in the activities by customers, of the type set forth above, may also result in significant benefits to the outlet associated with the interrogation zone, in terms of increased sales, customer traffic, etc.

Other features associated with the system and method of the present invention include the plurality of tags being more specifically structured to include enhanced storage capabilities which contain the history of a corresponding individual contained therein in addition to the individual identifier. As such, the classification data generated by the monitored tags, in response to receiving the interrogation signal, may serve to initially identify and thereby facilitate recognition of an individual such as through aforementioned individual identifier. In addition the enhanced storage capabilities may allow for the subsequent or concurrent transmission of the aforementioned individual history.

Moreover, in this preferred embodiment of the present invention the storage capabilities associated with the plurality of tags may also include an update application, which allows for the most current customer activity to be included within the individual history stored within the corresponding RFID tag. Such an update application may be specifically structured to interact with security monitors, cash registers or other facilities such as the aforementioned tracking assembly. Moreover, in at least one preferred embodiment the tracking assembly is operative to determine the locations and times spent within the various locations or departments of a visited outlet and include this information as a most current update of the “customer activity” of a tagged customer. As such, the update application may be receptive to wireless or direct contact communication, such as when a credit card or reward card in which the tag is embedded is processed to accomplish a purchase or other related activity associated with a customer activity regarding one or more products or services.

Alternatively, the history of the tagged individual or customer may be stored in a database associated with the aforementioned processor facility and/or reader assembly. In this embodiment the receipt of the individual identifier or other portion of the identification data by the reader will trigger access to the database associated with the processor facility which may be remote from the interrogation zone or be considered an associated part of the reader assembly. Such database access to the individual's history will allow for the determination of the hierarchy of individuals being monitored within the interrogation zone and thereby establish the selection order of individuals carrying tags and concurrently present within the interrogation zone. In this embodiment, the update application may also be operative as part of the processor facility, wherein the current customer activity of an individual will be communicated from a corresponding cash register, security monitor or other customer recognition facility to the processor facility for immediate update of an individual's history.

Yet another preferred embodiment of the system and method of the present invention relates to “customer tracking” as generally set forth above. More specifically, the customer tracking assembly incorporated within this additional preferred embodiment of the present invention allows a participating merchant outlet or like facility to be aware of the shopping habits, purchasing habits, browsing habits, etc. of at least one but more practically a plurality of “tagged” customers or individuals. As also generally set forth above, the outlet or merchant will thereby have the ability to “see” and keep track of a “customer's activity” including, but not limited to, what departments or sections of the interrogation area the customer visits while shopping, how long a given department or section is occupied by the customer, what merchandise is purchased or considered, what if any sales personnel a customer interacts with, etc.

Accordingly, this embodiment of the system and method of the present invention includes a plurality of tags each associated with a different one of the plurality of customers, wherein each of the plurality of tags includes response capabilities. The aforementioned tracking assembly includes monitoring capabilities directed to the interrogation area. Moreover, the monitoring capabilities include interrogation signaling communicatively interactive with each of the plurality of tags so as to activate the “response capabilities” of each tag when the interrogation signaling is received by the tag(s). Further, the response capabilities may include the generation or transmission of customer identification data to the tracking assembly when the tags associated with the plurality of customers or individuals receives the interrogation signaling from the tracking assembly.

As with the additional preferred embodiments, as set forth above, the customer identification data determines or facilitates access to the accumulated and/or stored customer activity data of corresponding one of the plurality of customers within the interrogation area. In addition, a recognition assembly is disposed within the interrogation area and structured to receive at least a portion of the customer identification data which is sufficient to facilitate recognition of individual ones of the plurality of customers corresponding to the generated customer identification data. Such recognition assembly may comprise a plurality of recognition devices or units each of which may be carried by or otherwise accessed by sales personnel in order that such sales personnel may recognize individual once the corresponding customer(s) enter or occupy a department or section of the interrogation section.

For purposes of clarity, the term “interrogation area” is used to describe this additional preferred embodiment and may be distinguishable from the aforementioned “interrogation zone”. Accordingly, as typically applied in the description of this preferred embodiment, the interrogation area may define or describe the area where the primary shopping activities take place and/or where the merchandise of the outlet is displayed, presented and otherwise offered for sale and/or inspection. Further, as used in description and definition of this additional preferred embodiment, the terms “customer” and “individual” are intended to be used interchangeably in the description of a person or persons in the possession of the at least one of the plurality of tags. Further, the tags referred to herein are of the type described above and specifically include RFID tags preferably having a UHF range of operation.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a schematic representation of at least one preferred embodiment of the system of the present invention.

FIG. 2 is a schematic representation of an RFID tag associated with the system and method of the present invention.

FIG. 3 is a schematic representation of a processor facility operatively associated with other components of the system and method of the present invention.

FIG. 4 is a schematic representation in block diagram form representing at least one embodiment of the method of the present invention.

FIG. 5 is a schematic representation in block diagram form which may be associated with the embodiment of FIG. 4 and represent yet another preferred embodiment of the present invention.

FIG. 6 is a schematic representation in block diagram form of another embodiment of the present invention which may be associated with the embodiment of FIG. 4.

FIG. 7 is a schematic representation in block diagram form of yet another preferred embodiment of the present invention.

FIG. 8 is a schematic representation in block diagram form of operative components associated with the embodiment of FIG. 6.

FIG. 9 is a schematic representation in block diagram form representative of a method of operation of the embodiment of FIGS. 7 and 8.

FIG. 10 is a schematic representation of an interrogation area associated with the operation of the embodiments of FIGS. 6-8.

Like reference numerals refer to like parts throughout the several views of the drawings.

### DETAILED DESCRIPTION OF THE PREFERRED EMBODIMENT

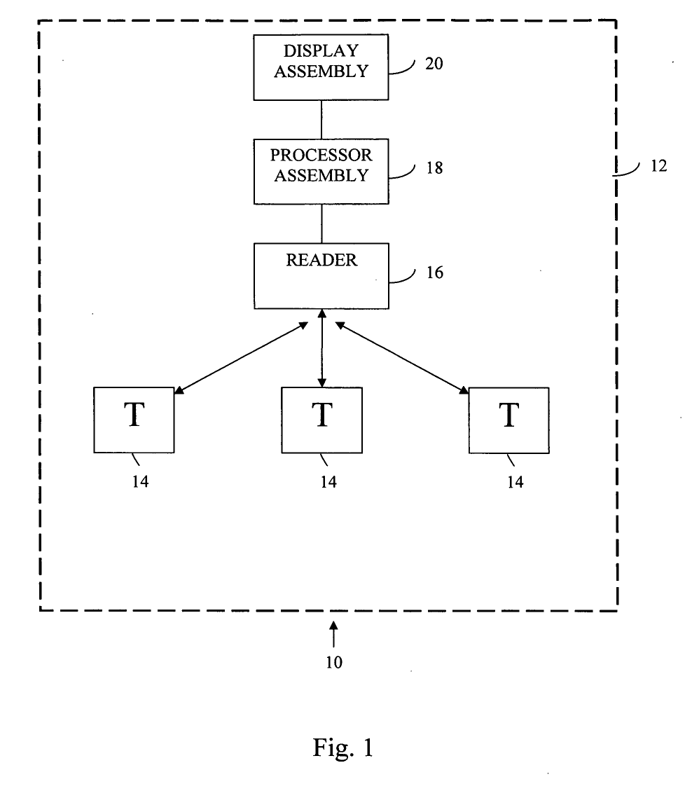

As represented in the accompanying Figures, the system of the present invention is generally indicated as 10 and includes a plurality of components schematically represented in their various embodiments in FIGS. 1 through 3. More specifically, at least one preferred embodiment of the present invention is directed to a system and method for generation of marketing presentations or displays, which are preferably electronically generated, to selected individuals present within an interrogation zone, generally indicated as 12, each of which are in the possession of a tag, more specifically a radio frequency identification (RFID) tag 14.

As also represented in FIG. 1, at least one monitoring reader generally indicated as 16 is located within or otherwise operatively associated with the interrogation zone 12. The reader(s) 16, and the plurality of tags 14 in the possession of different individuals present within the interrogation zone 12, are collectively capable of establishing a bi-directional communication therebetween. Further, in at least one preferred embodiment the bi-directional communication of the plurality of tags 14 and the reader 16 is operative within an ultra high frequency (UHF) range. This extended operative range enables the sizing of the interrogation zone to be significantly increased so as to be extended throughout relatively large areas in retail, wholesale or distribution environments. As such, the interrogation zone 12 may include part of a shopping mall or a variety of other public areas, where a plurality of individuals and/or potential customers may gather for purposes of shopping, product or service review, etc.

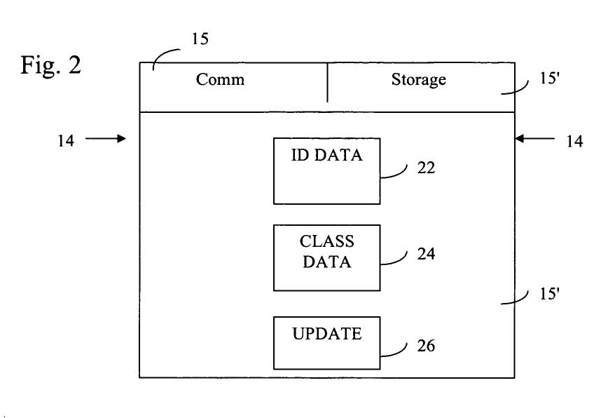

In addition, one or more processor facilities 18 are disposed in operative communication with the reader(s) 16. In at least one preferred embodiment the processor facility 18 may be directly associated therewith such as being commonly disposed and/or cooperatively structured. Alternatively, the processor facility 18 may be located remote from the reader 16 and from the interrogation zone 12 but still be connected, either through wireless or hard wire connections, to the reader 16 as well as a display facility or assembly 20. As will be explained in greater detail hereinafter, the display assembly 20 is capable of presenting video, audio or a combination thereof to the interrogation zone 12 and may include one or more display screens or like communicating display devices. As such, the display assembly 20 will be disposed and structured to enable substantially all of the individuals in the possession of the tags 14 to view or be exposed to the display assembly 20. As such, when a predetermined, customized and/or personalized marketing presentation is presented on the display assembly 20, it should be observable by substantially all of the individuals in possession of the tags 14 located within the interrogation zone 12. With primary reference to FIG. 2 as applied to the system of the embodiment of FIG. 1, each of the plurality of RFID tags 14 include the aforementioned communication capabilities 15 which are operable within a UHF band and which are further capable of bi-directional communication with the reader 16 and in certain applications, with the processor 18. Further, the plurality of RFID tags 14 may also include storage facilities 15′ and in at least one preferred embodiment the tag(s) 14 may further include appropriately enhanced storage facilities 15″. In either embodiment of the tag structure(s) 14 the respective storage and/or enhanced storage capabilities 15′ and 15″ cooperate with the communication facilities 15 of the corresponding tags 14 so as to facilitate data being communicated, in a manner set forth in greater detail hereinafter, to the reader 16 and/or the processor 18. More specifically, the enhanced storage facilities 15″ of the plurality of tags 14 may include the storage of identification data 22 and, in certain preferred embodiments, the additional storage of classification data 24. Further, an update application 26 may be directly associated with the classification data 24 so as to maintain a current history of an individual specifically, but not exclusively, relating to the most frequent or current “customer activities”. Such purchasing activities can include purchases and/or visitations associated with a specific outlet or outlets associated with and/or sponsoring the interrogation zone 12, and/or the monitoring procedures conducted therein. In at least one preferred embodiment the customer activity and accordingly the classification data 24 can be more detailed and specific and include departments and/or areas of an outlet most visited as well as personal customer preferences. More specifically, such personal customer preferences may include, but not be limited to, a category of merchandise frequently or typically purchased or shopped, amount of time typically spent in an outlet or department thereof, amount of money commonly or periodically spent, preferred sales personnel, preferred categories and/or specific brands of merchandise, etc.

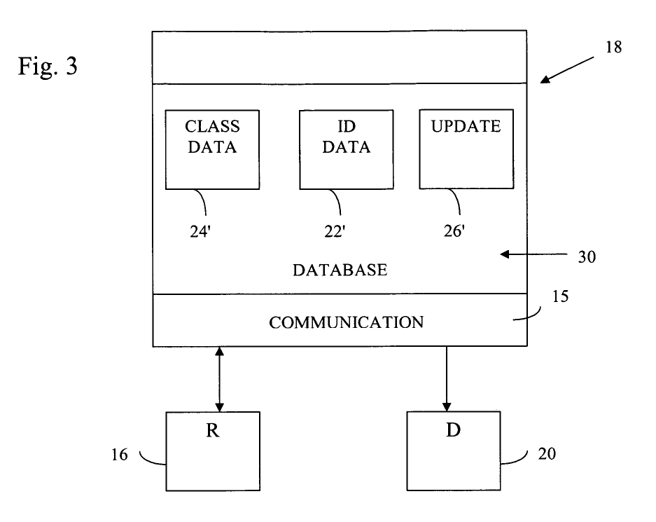

The preferred embodiment of FIG. 3 primarily applies to the system 10 of the embodiment of the embodiment of FIG. 1. Accordingly, the processor 18 also includes a data base 30 having sufficient appropriate storage facilities to store a plurality of customized messages, the content of which are delivered by the display assembly 20 to the plurality of individuals within the interrogation zone 12. As will be more apparent hereinafter, the content of the displayed message or presentation may be dependent, at least in part, on the selected individual to which the marketing message is directed. As also noted, the chosen message may be modified subsequent to selection to personalize the advertising content of the message at least to the extent of including a selected individual's name or other identifying characteristics which render the direct marketing message presented on the display assembly 20 recognizable by the selected individual.

The content of the message, as preferably electronically displayed, can also be directive and/or instructive at least to the extent of directing the selected customer/individual to a customer interactive location. By way of example, the customer may be directed to a kiosk or other readily accessible location or area which may include appropriate customer interface facilities such as, but not limited to, a keyboard, touch screen mouse or any other of a variety of customer input devices which allow the customer access to a coupon or other object representative of the awarded benefit he/she is to receive. As such the award may be printed on the coupon, etc or at least partially “hidden”, such as being encrypted in bar code or similar indicia.

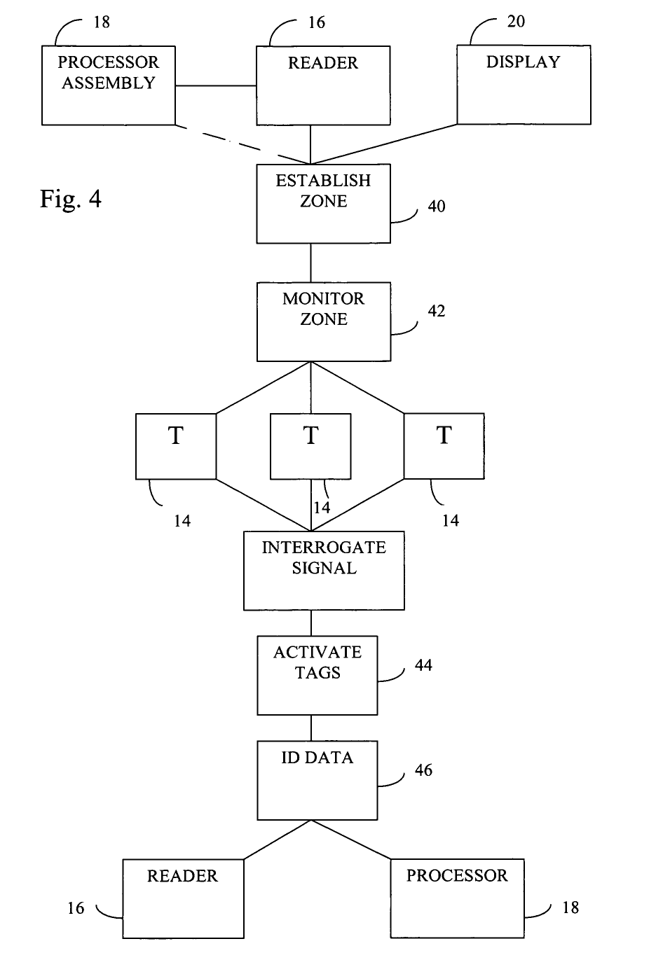

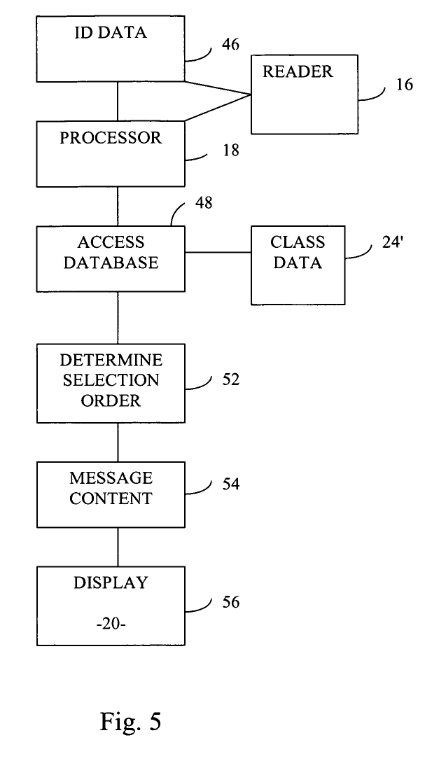

As will be explained in detail with regard to the method 100, as represented in FIGS. 4 and 5 as well as FIG. 3, the database 30 of the processor may also include a collection of classification data 24′ representing the histories or customer activities of all the individuals in the possession of the RFID tags. This is distinguishable from the embodiment of FIG. 2, wherein the classification data 24 of a single individual will be stored and maintained on that individual's tag 14 for eventual communication to the reader 16 and/or the processor 18. Accordingly, the classification data 24′ stored in the processor 18 will be a collection of all of the individuals in possession of the various RFID tags 14, wherein such histories may be pre-registered, stored and updated automatically by the update application or otherwise as required. In contrast, the classification data 24 stored in the enhanced storage capabilities of the RFID tag 14 only represents the history of the individual in possession of the tag 14, or other authorized user/individual such as a family member.

In either case each individual's history may include a variety of characteristics such as, but not limited to purchasing history, visitation frequency, purchasing patterns age, gender, economic level, geographical location, etc. As set forth in greater detail hereinafter, the classification data 24, 24′ may also include “customer activity” data which may primarily, but not exclusively, relates to the performance and practice of yet another preferred embodiment of the present invention. As such, the “customer activity” data may include the aforementioned individual's or customer's history as well as an enhanced and/or more specific record of a customer's shopping habits.

Accordingly, in the embodiment of FIGS. 1-6 at least some or predetermined ones of the factors of an individuals history or a combination of such factors are used to establish a selection order or hierarchy of individuals concurrently within the interrogation zone 12 at a given time. The selection order will be based on aforementioned hierarchy to the extent that the individual having the “best” or most appropriate history, based on the aforementioned factors, will be chosen as the selected individual to receive the direct marketing message or presentation observable on the display assembly 20 from preferably all parts of the interrogation zone 12.

With reference to FIG. 4, the method of operation and application associated with the system 10 is generally indicated as 100. Method 100 includes the communication of the reader 16, and in certain preferred embodiments the processor 20, being operatively associated and in bi-directional communication with the tags 14 present in the interrogation zone 12. Such bi-directional communication is established once the boundaries or dimensioning of the interrogation zone 12 is established as at 40. As set forth above, the plurality of RFID tags 14 and the reader 16 and possibly the communication capabilities associated with the processor 20, may operate on a UHF band. As such, the sizing of the interrogation zone 12 may be significantly enhanced while still maintaining reliable communication between the various components of the system 10, as set forth in greater detail hereinafter.

The method 100 further includes the continuous or periodic monitoring 42 of the interrogation zone using the aforementioned bi-directional communication between the RFID tags, reader 16 and possibly the processor 20. The monitoring 42 of the interrogation zone 12 comprises a periodic or continuously streaming interrogation signaling directed to any of a plurality of tags 14 currently located within the interrogation zone 12. When an interrogation signal 43 is received by the plurality of tags 14, the tags 14 are activated, as at 44, and thereafter perform the generation and transmission of identification data 46 back to the reader 16 and/or directly to the processor 18. The transmission of the identification data 46 more specifically includes the transmission of an individual identifier which corresponds to and/or facilitates the identity of the individual in possession of each of the plurality of tags 14. This individual identifier is, as set forth above, communicated directly to the reader and in turn transferred to the processor 18. Alternatively, the communication capabilities of the system 10, being bi-directional and within the UHF operational band, may accomplish transmission of the individual identifier directly to the processor 18.

Accordingly, at least one preferred embodiment of the present invention, as represented in FIG. 5, comprises the identifying signal transmitted either to the reader 16 or directly to the processor 18. In either case, the individual identifier will serve to access the database 30, as at 48, wherein further access to the collection of classification data as at 24′ is accomplished. The individual identifier will serve to locate the corresponding individual's history which will be reviewed to determine a hierarchy and eventual selection order as at 52, of the individuals present within the interrogation zone during a given monitoring period thereof. More specifically, the selection order is based on a hierarchy of the individual's history and more specifically relates to the individual having the “best” or most appropriate purchasing history, customer activity, or other factors or combination of factors which render one of the monitored individuals the best choice to be selected for receipt of the marketing presentation as presented by the display assembly 20. Therefore, once the history of the plurality of individuals located within the interrogation zone 12 has been chosen, the individual being selected will have a customized and/or personalized presentation directed to the selected individual throughout the interrogation zone 12 as at 56. The content of the customized direct marketing message may include various customer advantages such as reduced prices, products not previously available or other “bargains” not currently presented to other individuals located within the interrogation zone 12. Also, the message content observable on the display assembly 20, as at 56, will be sufficiently personalized to allow the selected individual to recognize himself or herself, so as to take advantage of the “bargains” evidenced by the content of the direct marketing message appearing on the display 20, as at 56.

As set forth above, the content of the message can also be informational and/or instructive at least to the extent of directing the selected customer/individual to a customer interactive location. By way of example, the customer may be directed to a kiosk or other readily accessible location or area which may include appropriate customer interface facilities such as any one or more of a variety of customer input devices which facilitate access to a coupon or other object representative of the awarded benefit or “bargain” the customer is to receive. As such the award or bargain may be printed or otherwise clearly displayed on the coupon. Alternatively, the bargain or award may be at least partially “hidden”, such as by being encrypted in bar code or similar indicia.

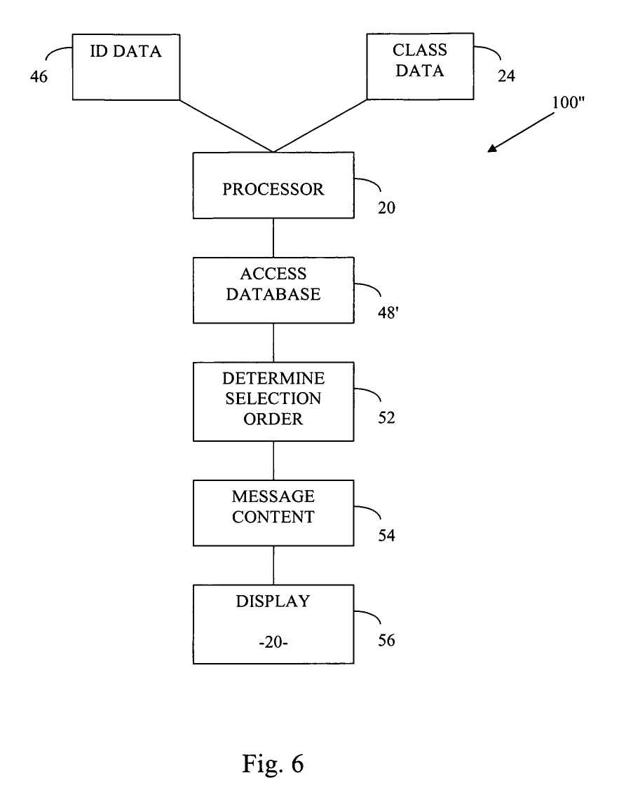

With the primary reference to FIG. 6 yet an additional embodiment of the present invention schematically represented a modification of the method, 100″. More specifically, in this embodiment the aforementioned classification data representing the individual's history and/or customer activity is stored on the corresponding tag 14 in his or her possession. As described with primary reference to FIG. 2, such individual classification data 24 is only representative of the individual in possession of the RFID tag 14 or other authorized individual. This is distinguishable from the embodiment schematically represented in FIG. 3, wherein a collection of the individual histories are stored on the processor 18, as at 24′ for all individuals in the possession of an RFID tag 14.

Further with regard to the embodiment of FIG. 6, once the tag is activated, the identification data in the form of the individual identifier 46 is transmitted to the reader 16 and/or directly to the processor 18, as at 46′. However, in addition after or concurrently to the transmission of the individual identifier 46 to the processor 18 (or the reader 16 and subsequently to the processor 18) the classification data 24 stored in the enhanced memory capability 15″ of each of the tags 14 will also be transmitted to the processor 18. Upon receipt of both the individual identifier 46 as at 46′ and the classification data 24 as at 46″, the processor will access the database associated with the processor as at 48′ for purposes of determining the selection order or hierarchy for all the individuals present within the interrogation zone 12 by a review of all the respective individual history associated therewith. The hierarchy or selection order will result in the selection of the most appropriate individual i.e., the individual having the best individual history or customer activity, as at 52.

Thereafter, similar to the embodiment of FIG. 5, the message content will be determined in terms of customizing the content for customer advantages or “bargains” and perhaps and in certain instances personalizing the message content as at 54 to assure that the selected individual will identify with the display marketing message presented on the display assembly 20 as at 56.

Each of the above noted embodiments of the present invention include the provision of an update application 26 and 26′ which allows for the most current customer activity to be included with the individual's history whether such customer activity data was stored as part of the individual classification data 24 in each of the tags 14 or the collective individual histories 24′ stored in the processor 18. Such an update application 26 and/or 26′ will be specifically structured to interact with the security monitors, cash registers or other purchasing or security monitoring facilities, such as those associated with and considered a part of a “tracking assembly” as described in detail hereinafter, within an interrogation area of a store, outlet, merchandise center etc. As such, when a credit card or reward card in which the individual RFID tag 14 are embedded are processed in terms of a purchase or other customer activity associated with a customer's presence, such activity will be updated to the extent that the classification data 24 or 24′ will be currently modified.

Other features associated with the practice of the system 10 and the method 100, 100′, 100″ of the present invention facilitate the possibility of the development of a “spirit of competition” by individuals present within the interrogation zone 12. More specifically, upon recognition by non-selected individual within the interrogation zone 12 that other individuals, having been selected, receives significant customer benefits “bargains”, the non-selected individuals may take specific steps to increase their chances of being selected. By way of example only, the non-selected individuals may visit or may purchases from the outlet or outlets associated with the interrogation zone 12 and/or may change their shopping patters so as to visit the outlet or outlets as well as the corresponding interrogation zone 12 during “off-hours” when there is normally fewer individuals or customers present. One of these activities may “improve” an individual's history thereby raising their hierarchy and selection order and most probably result in a better chance of being selected since they would be closer to the top of the selection order. Such an increase in customer or individual activities, of the type set forth above, may also result in significant benefits to the outlet or outlets associated with the interrogation zone 12.

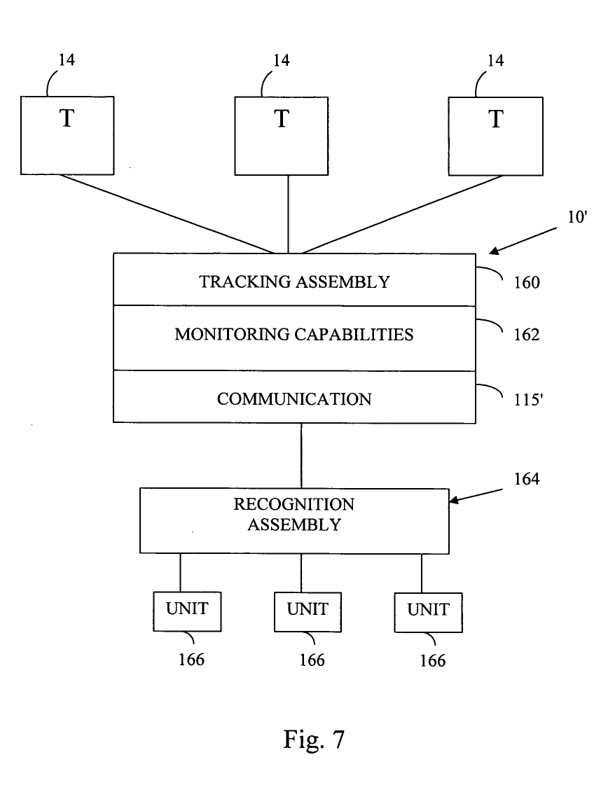

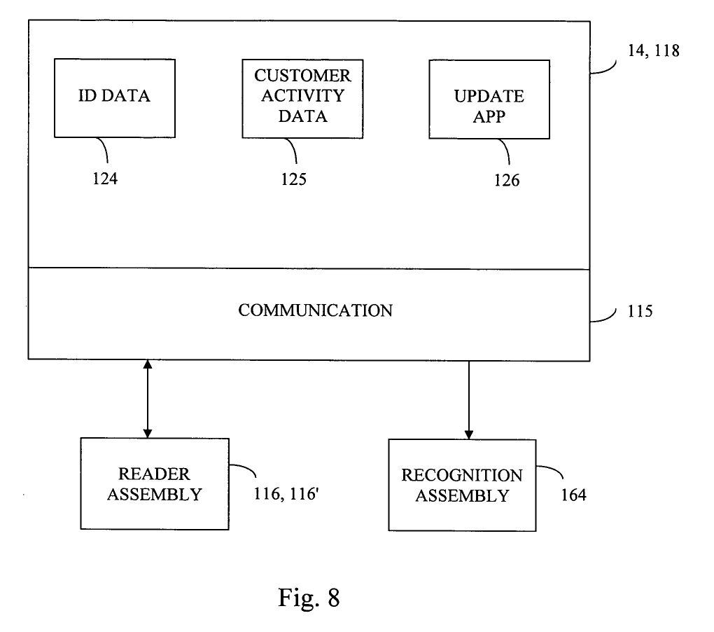

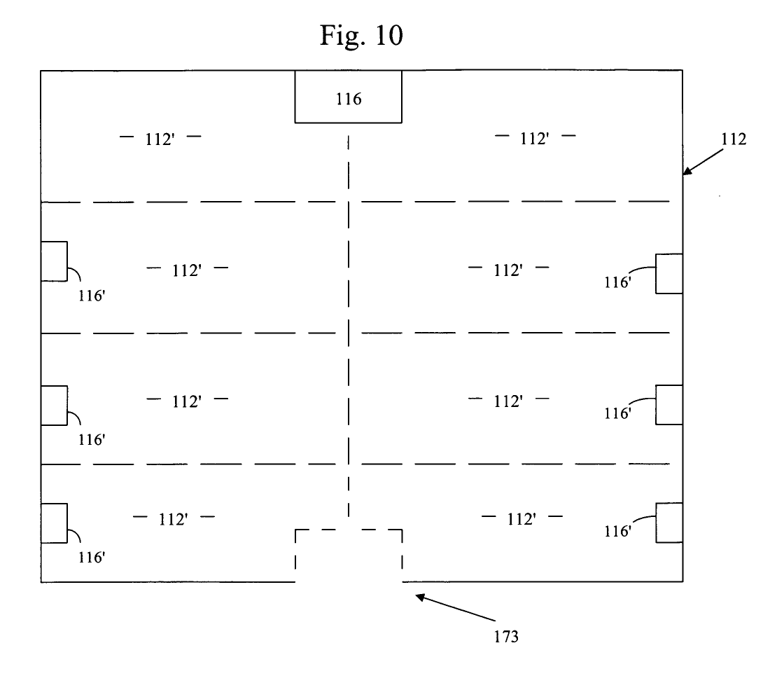

As primarily represented in FIGS. 7-10, yet another preferred embodiment of the system and method of the present invention is schematically represented therein. More specifically, FIGS. 7 and 8 are directed to a system 10′ including a plurality of tags 14 each of which are in the possession of an authorized individual/customer such as by being connected to a credit card, reward card, or other device easily stored on a customer's person. Further, this preferred embodiment of the system and method as represented in FIGS. 7-9 is associated with an interrogation area generally indicated as 112 in FIG. 10. The interrogation area 112 is to be distinguished from the interrogation zone 12 associated with the embodiments of FIGS. 1-6. More specifically, the interrogation area 112 comprises or at least partially defines the main shopping area for customers such as, but not limited to the interior of a department store or other merchant outlet of various types and sizes.

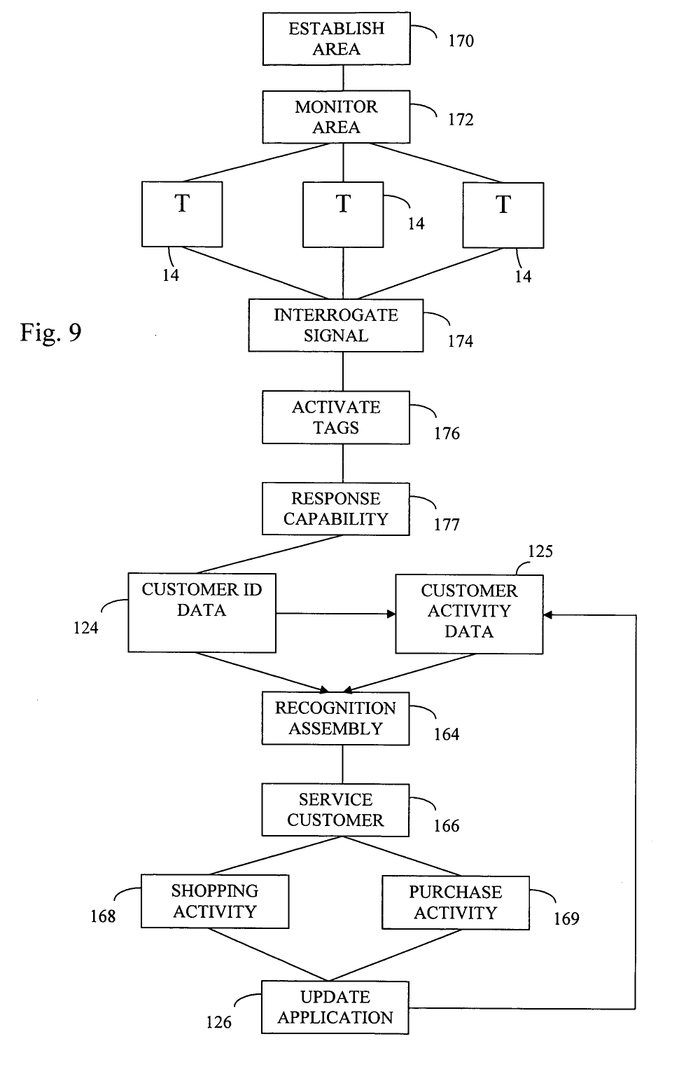

In addition and as typically designed, the shopping or interrogation area 112 is at least minimally segregated into a plurality of “departments” or “sections” each of which are indicated as 112′. More specifically and as typically found in department stores as well as a variety of other retail or merchandise outlets, the main shopping area or interrogation area 112 comprises a plurality of sections 112′ each of which may contain and/or display a different category of merchandise. By way of example, most department stores include men's and women's clothing departments, shoe departments, a sporting good department, a furniture department, kitchenware department, etc. Further, these different departments or sections 112′ may or may not be physically segregated by a partition, wall or similar barrier. More frequently, each of the sections or departments 112′ are freely open to facilitate passage of customers through each of the departments 112′ in order that the merchandise offered for sale can be adequately and effectively displayed. Therefore, the phantom lines represented in FIG. 9 are provided as schematic boundaries or demarcations which serve to distinguish one of the departments or sections 112′ from the next adjacent or contiguous department or section 112′.

Again with primary reference to FIGS. 7 and 8, as practiced and operative within the interrogation area 112 of FIG. 10, the system 10′ comprises a tracking assembly 160 which includes monitoring capabilities 162. The monitoring capabilities 162 are preferably, but not necessarily, performed by a reader assembly comprising at least one reader 116 disposed within the interrogation area 112 and structured so as to monitor each of the departments or sections 112′ independently of the other. Accordingly, yet another operative modification of the tracking assembly 160 includes the reader assembly 116 comprising a plurality of readers 116′ each of which are located in a different one of the departments or sections 112′. As such, each of the departmental readers 116′ is disposed and structured to perform the monitoring capabilities 162 in the corresponding one of the departments or sections 112′. Therefore, as a customer passes into the interrogation area 112, he or she will typically pass through one or more of the departments or sections 112′ of the interrogation area 112. As such, corresponding ones of the individual readers 116′ will detect the existence of the tag of the individual within a given one of the departments or sections 112′.

As with the above-noted embodiments of FIGS. 1-5, the monitoring capabilities include an interrogation signaling capabilities generated by the reader assembly 116, 116′ such that each of the tags 14 within a given department or section 112′ will be activated. Such activation will cause the individual tags 14, due to the existence of response capabilities present in each of the tags 14, to transmit or generate customer identification data as at 124. The customer identification data 124 will be transmitted from the tags and/or from a processor 118 to the tracking assembly 160. Such customer identification data 124 will be determinative of access at least to customer activity data 125 stored on the processor 118 and/or on the enhanced storage capabilities of the tag(s) 14. Therefore, at least one feature of this preferred embodiment of the system 10′ includes the customer identification data 124 being stored on the individual tags 14 and/or on a processor 118 similar to the processor 18 as represented in FIG. 3 in the system 10 of previously described embodiments.

Further, the customer activity data comprises a purchasing and/or shopping history and/or detailed record of the shopping and/or purchasing habits specifically, but not exclusively, as they relate to a given merchant or retail outlet, such as that associated with the interrogation area 112. More specifically, the customer activity data of any given customer may include personal customer preferences including, but not limited to, a category of merchandise frequently or typically purchased or shopped, the amount of time which a customer occupies a given department or section 112′, the amount of money commonly or periodically spent by the customer, preferred sales personnel which the customer may request or may typically interact with, a preferred category or specific brand of merchandise, etc. This type of customer activity data allows for a better servicing of tagged customers and a result in increase in sales of the retail or merchant outlet associated with interrogation area 112.

Therefore, the tracking assembly 160 has sufficient communication capabilities 115′ to communicate both with the plurality of tags 14 and with a recognition assembly generally indicated as 164. As such, the preferred embodiment of the system 10′, comprises a recognition assembly 164 including a plurality of recognition units and devices 166, wherein at least one of the recognition units or devices 166 is located in each of the interrogation area departments or sections 112′. Further the recognition units or devices 166 are provided with appropriate display features which allow sales personnel in each of the departments or sections 112′ to recognize tagged individuals which are being monitored by the tracking assembly 160 including the reader assembly and/or plurality of readers 116, 116′. Further, the recognition units 166 may be portable units, which communicate wirelessly with the tracking assembly 160 through the communication capabilities 115′. Further, the communication between each of the recognition units 166 may be with the reader assembly 116 and/or plurality of reader devices 116′ by wireless communication. Also, the recognition units or devices 166 may be portable and carried by each or a designated plurality of sales personnel as the sales personnel wonders through the separate interrogation area, departments or outlets 112′, servicing various customers shopping within such areas 112′. Additional features of the recognition assembly 164 includes adequate display facilities or monitors, as set forth above, incorporated within the portable, wireless units 166 or alternatively in other purchasing facilities such as cash registers, counters or card readers, security monitors, etc. Such appropriate and adequate display facilities may include a display screen wherein at least a portion of the customer identification data transmitted to the recognition assembly 164 and/or units 166 may be a photograph of the customer being monitored, as that customer passes through a corresponding one of the departments or sections 112′ of the interrogation area 112.

The system 10′ of the present invention is practiced and/or applied within any one of a plurality of different interrogation areas 112, as generally set forth above. Accordingly, practice of the system 10′, in accord with the method 200 schematically represented in FIG. 10, includes the establishing or determining the interrogation area 112, as at 170 including the determination of each of the departments or sections 112′. In the establishing or defining of the interrogation area 112 and/or individual departments 112′, sufficient monitoring must be accomplished individually in each of the departments of areas 112′ such that the entire interrogation area 112 is effectively monitored, as at 172.

Accordingly, when the various tags 14 in the possession of corresponding customers enter the interrogation area 112 they are activated through a security monitor generally indicated as 173 in FIG. 10 and/or by the reader assembly 116 and/or individual readers 116′ in the various departments or sections 112. Activation of the tags 114 will be accomplished by the generation of an interrogation signaling 174 which may be considered a part of the monitoring capabilities 162 of the tracking assembly 160. In a more specific operative and structural modification, the interrogation signaling 174 is generated by the reader assembly 116, 116′ through the communication facilities 115 or 115′ associated with either the tracking assembly 160 and/or the individual tags 14 and possibly an associated processor 118.

As the individual tags 14 receive the interrogation signaling 174 the tags will be activated as at 176, which in turn will cause the activation of the response capabilities 177 associated with each of the tags 114. As a result, customer identification data 124 will be transmitted to the tracking assembly 160 and/or the processor 118 thereby providing access to the customer activity data 125 representing the purchasing and shopping history, as well as other characteristics of each of the plurality of customers.

Thereafter, at least a portion of the customer identification data will be transmitted to the recognition assembly 164 and/or to each of the individual recognition units or devices 166. This portion of the customer identification data 124 will be sufficient to allow the recognition assembly to display or generate sufficient information, possibly including a photograph, to facilitate the identification of the tagged customer, by the sales personnel in each of the departments or sections 112′. As a result, the sales personnel can clearly recognize and therefore effectively serve the customer. Accordingly, the tracking assembly 160 including the operative components associated therewith will facilitate the “visibility” of each shopper as they pass through one or more of the departments or sections 112′. Such visibility will allow the outlet or merchant associated with the interrogation area 112 to determine the shopping activity as at 168 of the individual customers as well as the purchasing activity 169.

As with the embodiments of the system and method of the present invention associated with FIGS. 1-5, this preferred embodiment of the system 10′ includes an update application as at 126. The update application is operative to store the customer activity data 125 of each of the plurality of tagged customers at least to the extent of placing into storage the latest or most current shopping activities including purchasing activities as at 168 and 169 respectively. In addition and as set forth above, the update application will enter into the customer activity data 125 of each of the plurality of tagged customers additional factors. Such additional factors may include preferred merchandise or categories of merchandise most shopped, a dollar amount of purchases, frequency of shopping and/or purchasing, time occupied in each of the departments or sections 112′ visited by the tagged customers and a plurality of other factors, such as preferred sales personnel, frequency of visits to the interrogation area 112, etc.

Moreover, the update application 126 may be associated with any of the processing equipment utilized when a customer purchases merchandise and as such may be also communicatively interactive with the cash registers, credit card readers, etc. located in each of the departments or sections 112′. Further, the tagged customers refer to in the practice of the additional preferred embodiment of FIGS. 7-10 may be separate from the selected customer as described with the preferred embodiment of FIGS. 1-5. Accordingly, a plurality of tagged customers may be concurrently monitored utilizing the tracking assembly 160 and its effective monitoring capabilities 162 in cooperation with the reader assembly 116, 116′ and the recognition assembly 164 which may include the individual recognition units 166.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A system of marketing to a predetermined plurality of customers within a predetermined interrogation area, said system comprising:
a plurality of tags each associated with a different one of the plurality of customers, each of said plurality of tags including response capabilities,
a tracking assembly including monitoring capabilities directed to the interrogation area,
said monitoring capabilities including interrogation signaling communicatively interactive with said response capabilities of said plurality of tags at least within the predetermined interrogation area,
said response capabilities including transmission of customer identification data to said tracking assembly in response to receipt of said interrogation signaling,
said customer identification data determinative of access to customer activity data of a corresponding one of the plurality of customers within the interrogation area, and
a recognition assembly disposed within the interrogation area and structured to receive at least a portion of said customer identification data sufficient to facilitate recognition of the customer corresponding to said customer identification data.

2. A system as recited in claim 1 wherein said recognition assembly is disposed in communicating relation with at least some of said plurality of tags and receptive of said portion of customer identification data from said plurality of tags.

3. A system as recited in claim 1 wherein said recognition assembly is disposed in communicating relation with said tracking assembly and receptive of said portion of customer identification data from said tracking assembly.

4. A system as recited in claim 3 wherein said tracking assembly comprises transceiver capabilities structured to establish communication with said plurality of tags and with said recognition assembly.

5. A system as recited in claim 4 wherein said transceiver capabilities are structured for wireless communication.

6. A system as recited in claim 3 wherein said recognition assembly comprises a plurality of recognition units each receptive of said portion of customer identification data, at least one of said plurality of recognition units operatively disposed within each of a plurality of predetermined sections of the interrogation area.

7. A system as recited in claim 6 wherein at least some of said plurality of recognition units are portable.

8. A system as recited in claim 3 wherein said portion of said customer identification data comprises a photograph of a corresponding one of the plurality of customers.

9. A system as recited in claim 1 wherein said tracking assembly comprises a reader assembly disposed within the interrogation area and operative to perform said monitoring capabilities within the interrogation area.

10. A system as recited in claim 9 wherein said reader assembly is disposed and structured to perform said monitoring capabilities within each of a plurality of predetermined sections of the interrogation area.

11. A system as recited in claim 10 wherein said reader assembly is disposed and structured to independently perform said monitoring capabilities within each of the sections of the interrogation area.

12. A system as recited in claim 11 wherein said reader assembly is further structured to distinguish said customer identification data dependent on from which of the plurality of sections it originates.

13. A system as recited in claim 10 wherein said reader assembly and said monitoring capabilities are operative to determine which of the plurality of sections of the interrogation area the each of the plurality of customers are located.

14. A system as recited in claim 13 wherein said reader assembly and said monitoring capabilities are operative to determine the time of occupancy of each of the plurality of customers in each of the plurality of sections.

15. A system as recited in claim 1 wherein said tracking assembly is disposed and structured to perform said monitoring capabilities within each of a plurality of interrogation area sections independently of the other of the plurality of interrogation area sections.

16. A system as recited in claim 15 wherein said tracking assembly is structured to communicate at least a portion of said customer activity data to said recognition assembly.

17. A system as recited in claim 16 wherein said portion of said customer activity data comprises sales personnel preferences.

18. A system as recited in claim 16 wherein said portion of said customer activity data comprises merchandise preferences.

19. A system as recited in claim 16 wherein said recognition assembly comprises a plurality of recognition devices each receptive of said portion of said customer activity data; at least one of said plurality of recognition devices operatively disposed within each of the plurality of interrogation area sections.

20. A system as recited in claim 1 further comprising an update application operative to modify said customer activity data corresponding to a current shopping activity of a corresponding customer.

21. A system as recited in claim 20 wherein said current shopping activity includes merchandise purchasing activity.

22. A method of marketing to a predetermined plurality of customers within a predetermined interrogation area, the method comprising:
establishing the interrogation area, monitoring the interrogation area for any of a plurality of tags present within the interrogation area, activating the present tags by interrogation signaling,
receiving responses from the activated tags in the form of customer identification data,
accessing customer activity data corresponding to the customer identification data,
communicating at least a portion of the customer identification data to a recognition assembly within the interrogation area, and
identifying and servicing the customer corresponding to the portion of the customer identification data received by the recognition assembly.

23. A method as recited in claim 22 further comprising monitoring the plurality of customers in each of a plurality of departments of which the interrogation area is comprised.

24. A method as recited in claim 23 defining the customer activity data to include current shopping activity of a corresponding customer within the individual departments of the interrogation area.
